(19) United States
(12) Patent Application Publication
(10) Pub. No.: US 2022/0188822 A1
(43) Pub. Date: Jun. 16, 2022

(54) SYSTEM, METHOD AND COMPUTER READABLE MEDIUM FOR PERFORMING A TRANSACTION IN RELATION TO AN IDENTITY CENTRIC DATASET

(71) Applicant: TGrid Technologies Pty Ltd, Sydney New South Wales (AU)

(72) Inventors: Anton Guzhevskiy, Sydney, New South Wales (AU); Santosh Devaraj, Sydney, New South Wales (AU)

(21) Appl. No.: 17/426,617

(22) PCT Filed: Jan. 31, 2020
(86) PCT No.: PCT/AU2020/050061

§ 371 Date: Jul. 28, 2021

(30) Foreign Application Priority Data
Feb. 1, 2019 (AU) 2019900309
Feb. 1, 2019 (AU) 2019900310
Oct. 4, 2019 (AU) 2019903748

(51) Int. Cl. G06Q 20/40; G06Q 20/32; G06Q 20/38

(52) U.S. Cl. CPC G06Q 20/405; G06Q 20/4014; G06Q 2220/00; G06Q 20/3825; G06Q 20/3827; G06Q 20/3227

(57) ABSTRACT

Disclosed is a method, system and computer readable medium for performing a transaction in relation to an identity centric dataset. In one aspect, the method comprises: establishing, by a consortium network, a set of permitted data operations for a service network using a plurality of privacy schemas; receiving, by the service network, a transaction request to perform the transaction in relation to the identity centric dataset associated with a data owner; identifying, by the service network from the plurality of schemas and based on the transaction request, a privacy schema from the plurality of privacy schemas for use in performing the transaction; performing the transaction by executing, in a trusted execution environment of the service network, one or more data operations from the set of permitted data operations upon the identity centric dataset of the data owner as permitted by the identified privacy schema thereby generating a manipulated dataset and transaction metadata; recording the transaction metadata to a distributed ledger of the service network; and transferring the manipulated dataset to a data receiver indicated by the transaction request.

### TECHNICAL FIELD

The current application claims priority from Australian Provisional Patent Application No. 2019900309, filed 1 Feb. 2019, Australian Provisional Patent Application No. 2019900310, filed 1 Feb. 2019, and Australian Provisional Patent Application No. 2019903748, filed 4 Oct. 2020. Australian Provisional Patent Application No. 2019900309, Australian Provisional Patent Application No. 2019900310 and Australian Provisional Patent Application No. 2019903748 are herein incorporated by reference in their entirety.

### TECHNICAL FIELD

The present invention relates to a system, method and computer readable medium for performing a transaction in relation to an identity centric dataset.

### BACKGROUND

In recent years, a significant number of organisations have been developing new-generation services utilising distributed ledger technology (also known as ‘blockchain’) in permissioned enterprise environments. Most of these services are focused on specific use cases, such as supply chain management, financial use cases, or self-sovereign digital identity. While used in private enterprise environments, most of these systems are implemented based on design principles prevalent in public blockchain systems, inheriting limitations with confidentiality and privacy of transactions.

For example, there are existing blockchain-implemented identity systems, where identity attributes are stored off-chain (outside of the distributed ledger network), with identity identifiers recorded to a distributed ledger in a form of anonymous or pseudo-anonymous keys. These systems allow users to issue anonymous or pseudonymous assertions of their identity attributes, thus providing for a certain level of privacy of identity attributes and associated transactions. However, in cases where transactional policies need to be implemented in the form of blockchain-encoded smart contracts, such systems cannot provide strong privacy and confidentiality because, by design, all smart contract instructions are available to all nodes on the distributed network.

### SUMMARY

It is an object of the present invention to substantially overcome or at least ameliorate one or more disadvantages of existing arrangements.

In a first aspect there is provided a method of performing a transaction in relation to an identity centric dataset, wherein the method comprises: establishing, by a consortium network, a set of permitted data operations for a service network using a plurality of privacy schemas; receiving, by the service network, a transaction request to perform the transaction in relation to the identity centric dataset associated with a data owner; identifying, by the service network from the plurality of schemas and based on the transaction request, a privacy schema from the plurality of privacy schemas for use in performing the transaction; performing the transaction by executing, in a trusted execution environment of the service network, one or more data operations from the set of permitted data operations upon the identity centric dataset of the data owner as permitted by the identified privacy schema thereby generating a manipulated dataset and transaction metadata; recording the transaction metadata to a distributed ledger of the service network; and transferring the manipulated dataset to a data receiver indicated by the transaction request.

In certain embodiments, the privacy schema is identified from the plurality of privacy schemas based on at least one of the data owner and the data receiver as indicated by the transaction request.

In certain embodiments, the method further comprises transferring a transaction identifier of the transaction to the data owner.

In certain embodiments, the one or more data operations comprise at least one of: a data transformation operation; a data encryption operation; a data privacy preservation operation; a data anonymization operation; a data pseudo-anonymisation operation; a data tokenization operation; a data enrichment operation; a data label assignment operation; a data classification label assignment operation; and a data dissemination marker assignment operation.

In certain embodiments, the transaction metadata is indicative of: one or more identity attribute identifiers; a transaction context; consent of the data owner; an identifier of the data owner; an identifier of the data receiver; and an identifier of each identifiers of the one or more data operations.

In certain embodiments, the transaction request is indicative of the consent of the data owner and the transaction context.

In certain embodiments, the privacy schema is identified from the plurality of privacy schemas based on at least one of the consent of the data owner and the transaction context

In certain embodiments, the manipulated dataset comprises one or more transaction data records and the transaction metadata.

In certain embodiments, the transaction metadata is appended to the one or more transaction data records.

In certain embodiments, the service network includes a service application programming interface (API), wherein the transaction request is received from a data owner device via the service API.

In certain embodiments, at least some of the manipulated dataset is encrypted by the service network based on the one or more data operations, wherein the method further comprises: receiving, via the service API, a data access request; determining, based on the data access request, if the data receiver is permitted to perform decryption of the at least some of the manipulated dataset; and if the data receiver is determined to be permitted: generating and transferring, to the data receiver, a decryption key to enable the data receiver to decrypt the at least some of the manipulated dataset; and recording, by the service network, further transaction metadata to the distributed ledger.

In certain embodiments, the method further comprises configuring the service network by initialising one or more system nodes based on a plurality of smart contracts and the plurality of privacy schemas distributed via a further distributed ledger, wherein the plurality of smart contracts encode the plurality of data operations.

In certain embodiments, the consortium network includes a plurality of system nodes, wherein the method further comprises: establishing the service network, wherein the one or more system nodes are part of the plurality of system nodes.

In a second aspect there is provided a system of performing a transaction in relation to an identity centric dataset, wherein the system comprises one or more processing systems configured to: establish a set of permitted data operations for a service network using a plurality of privacy schemas; receive a transaction request to perform the transaction in relation to the identity centric dataset associated with a data owner; identify, from the plurality of schemas and based on the transaction request, a privacy schema from the plurality of privacy schemas for use in performing the transaction; perform the transaction by executing, in a trusted execution environment of the service network, one or more data operations from the set of permitted data operations upon the identity centric dataset of the data owner as permitted by the identified privacy schema thereby generating a manipulated dataset and transaction metadata; record the transaction metadata to a distributed ledger of the service network; and transfer the manipulated dataset to a data receiver indicated by the transaction request.

In certain embodiments, the privacy schema is identified from the plurality of privacy schemas based on at least one of the data owner and the data receiver as indicated by the transaction request.

In certain embodiments, the consortium network is configured to transfer a transaction identifier of the transaction to the data owner.

In certain embodiments, the one or more data operations comprise at least one of: a data transformation operation; a data encryption operation; a data privacy preservation operation; a data anonymization operation; a data pseudo-anonymisation operation; a data tokenization operation; a data enrichment operation; a data label assignment operation; a data classification label assignment operation; and a data dissemination marker assignment operation.

In certain embodiments, the transaction metadata is indicative of: one or more identity attribute identifiers; a transaction context; consent of the data owner; an identifier of the data owner; an identifier of the data receiver; and an identifier of each identifiers of the one or more data operations.

In certain embodiments, the transaction request is indicative of the consent of the data owner and the transaction context.

In certain embodiments, the privacy schema is identified from the plurality of privacy schemas based on at least one of the consent of the data owner and the transaction context.

In certain embodiments, the manipulated dataset comprises one or more transaction data records and the transaction metadata.

In certain embodiments, the transaction metadata is appended to the one or more transaction data records.

In certain embodiments, the service network includes a service application programming interface (API), wherein the transaction request is received from a data owner device via the service API.

In certain embodiments, at least some of the manipulated dataset is encrypted by the service network based on the one or more data operations, wherein the consortium network is further configured to: receive, via the service API, a data access request; determine, based on the data access request, if the data receiver is permitted to perform decryption of the at least some of the manipulated dataset; and if the data receiver is determined to be permitted: generate and transfer, to the data receiver, a decryption key to enable the data receiver to decrypt the at least some of the manipulated dataset; and record, by the service network, further transaction metadata to the distributed ledger.

In certain embodiments, the one or more processing systems configure the service network by initialising one or more system nodes based on a plurality of smart contracts and the plurality of privacy schemas distributed via a further distributed ledger, wherein the plurality of smart contracts encode the plurality of data operations.

In certain embodiments, the consortium network includes a plurality of system nodes, wherein the one or more processing systems are configured to establish the service network, wherein the one or more system nodes are part of the plurality of system nodes.

In a third aspect there is provided one or more non-transitory computer readable mediums have stored therein or thereon executable instructions which when executed by one or more processors of one or more processing systems, configure the one or more processing systems to: establish a set of permitted data operations for a service network using a plurality of privacy schemas; receive a transaction request to perform the transaction in relation to the identity centric dataset associated with a data owner; identify, from the plurality of schemas and based on the transaction request, a privacy schema from the plurality of privacy schemas for use in performing the transaction; perform the transaction by executing, in a trusted execution environment of the service network, one or more data operations from the set of permitted data operations upon the identity centric dataset of the data owner as permitted by the identified privacy schema thereby generating a manipulated dataset and transaction metadata; record the transaction metadata to a distributed ledger of the service network; and transfer the manipulated dataset to a data receiver indicated by the transaction request.

In certain embodiments, the privacy schema is identified from the plurality of privacy schemas based on at least one of the data owner and the data receiver as indicated by the transaction request.

In certain embodiments, the consortium network is configured to transfer a transaction identifier of the transaction to the data owner.

In certain embodiments, the one or more data operations comprise at least one of: a data transformation operation; a data encryption operation; a data privacy preservation operation; a data anonymization operation; a data pseudo-anonymisation operation; a data tokenization operation; a data enrichment operation; a data label assignment operation; a data classification label assignment operation; and a data dissemination marker assignment operation.

In certain embodiments, the transaction metadata is indicative of: one or more identity attribute identifiers; a transaction context; consent of the data owner; an identifier of the data owner; an identifier of the data receiver; and an identifier of each identifiers of the one or more data operations.

In certain embodiments, the transaction request is indicative of the consent of the data owner and the transaction context.

In certain embodiments, the privacy schema is identified from the plurality of privacy schemas based on at least one of the consent of the data owner and the transaction context.

In certain embodiments, the manipulated dataset comprises one or more transaction data records and the transaction metadata.

In certain embodiments, the transaction metadata is appended to the one or more transaction data records.

In certain embodiments, the service network includes a service application programming interface (API), wherein the transaction request is received from a data owner device via the service API.

In certain embodiments, at least some of the manipulated dataset is encrypted by the service network based on the one or more data operations, wherein at least some of the executable instructions, which when executed by the one or more processors, configure the consortium network to: receive, via the service API, a data access request; determine, based on the data access request, if the data receiver is permitted to perform decryption of the at least some of the manipulated dataset; and if the data receiver is determined to be permitted: generate and transfer, to the data receiver, a decryption key to enable the data receiver to decrypt the at least some of the manipulated dataset; and record, by the service network, further transaction metadata to the distributed ledger.

In certain embodiments, execution of at least some executable instructions cause the one or more processing systems to configure the service network by initialising one or more system nodes based on a plurality of smart contracts and the plurality of privacy schemas distributed via a further distributed ledger, wherein the plurality of smart contracts encode the plurality of data operations.

In certain embodiments, the consortium network includes a plurality of system nodes, wherein execution of at least some of the executable instructions by the one or more processors configure the one or more processing systems to establish the service network, wherein the one or more system nodes are part of the plurality of system nodes.

In another aspect there is provided a system for performing a transaction in relation to an identity centric dataset, the system comprising one or more processing systems configured to perform a method according to the first aspect.

In another aspect there is provided one or more non-transitory computer readable mediums having stored therein or thereon executable instructions which, when executed by one or more processors of one or more processing systems, configure the one or more processing systems to perform a method according to the first aspect.

Other aspects and embodiments will be appreciated throughout the detailed description.

### BRIEF DESCRIPTION OF THE DRAWINGS

Example embodiments should become apparent from the following description, which is given by way of example only, of at least one preferred but non-limiting embodiment, described in connection with the accompanying figures.

FIGS. 1A and 1B form a schematic block diagram of a computer system upon which arrangements described can be practiced;

FIG. 2 illustrates an example of a computing device with trusted execution environment (TEE) functionality which can be used as a system node.

FIG. 3 is a block diagram representing a system for performing data transactions upon an identity centric dataset.

FIG. 4 is a flowchart representing a method of performing a transaction in relation to an identity centric dataset.

FIG. 5 is a block diagram illustrating a plurality of computer program modules executable by a system node.

FIG. 6 is a block diagram representing an example of an identity ledger used by the system of FIG. 3.

FIG. 7 is a flowchart representing an example method of performing system initialisation and transaction processing.

FIG. 8 is a flowchart representing a method of establishing a consortium network;

FIG. 9 is a flowchart representing a method of a system node joining an established consortium network;

FIG. 10 is a flowchart representing a method of a system node joining a service network of the consortium network.

FIG. 11 is a block diagram illustrating an example of a privacy preserved dataset.

FIG. 12 is a flowchart representing a method performed by the privacy and consent broker component of one of the system nodes.

FIG. 13 is a schematic showing an example of multiple aggregated identity representations.

FIGS. 14 and 15 are schematics representing an example of a service integration API, a plurality of privacy schemas and a plurality of privacy contracts.

FIG. 16 is a schematic illustrating an example of multiple privacy preserved datasets which are distributed to various data receivers based on various consent data provided by the data owner.

FIG. 17 is a schematic showing a graphical user interface (GUI) provided by a system node for configuration of identity data processing workflows.

### DETAILED DESCRIPTION

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

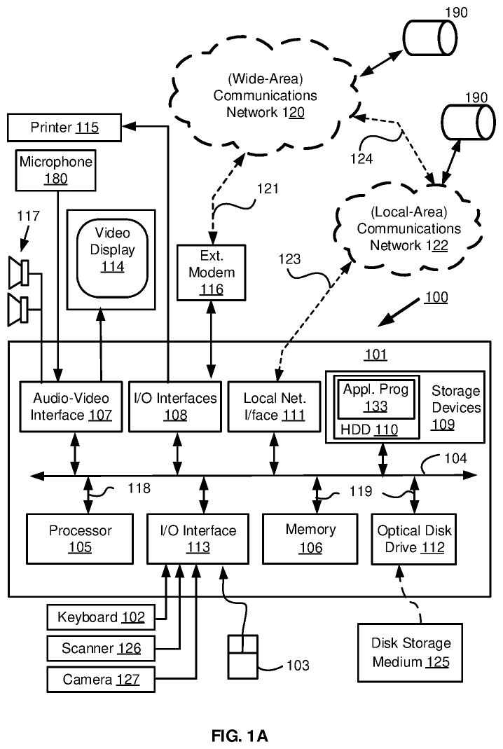

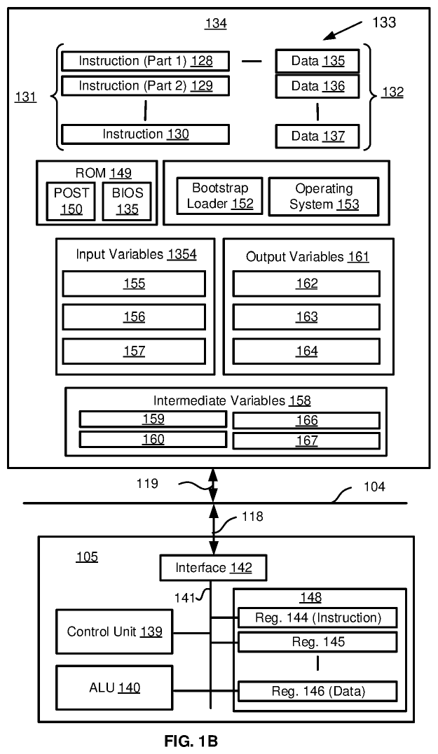

FIGS. 1A and 1B depict a computer system 100, upon which the various arrangements described can be practiced.

As seen in FIG. 1A, the computer system 100 includes: a computer module 101; input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105, and a memory unit 106. For example, the memory unit 106 may have semiconductor random access memory (RAM) and semiconductor read only memory (ROM). The computer module 101 also includes a number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1A, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or like computer systems.

The methods disclosed herein may be implemented using the computer system 100 wherein the processes, to be described, may be implemented as one or more software application programs 133 executable within the computer system 100. In particular, the steps of the methods described herein are effected by instructions 131 (see FIG. 1B) in the software 133 that are carried out within the computer system 100. The software instructions 131 may be formed as one or more code modules, each for performing one or more particular tasks. The software may also be divided into two separate parts, in which a first part and the corresponding code modules performs the disclosed methods and a second part and the corresponding code modules manage a user interface between the first part and the user.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product.

The software 133 is typically stored in the HDD 110 or the memory 106. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-Ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1B is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1A.

When the computer module 101 is initially powered up, a power-on self-test (POST) program 150 executes. The POST program 150 is typically stored in a ROM 149 of the semiconductor memory 106 of FIG. 1A. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1A. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high-level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1A must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1B, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1A. The execution of a set of the instructions may in some cases result in output of data. Execution may also involve storing data or variables to the memory 134.

The disclosed arrangements use input variables 154, which are stored in the memory 134 in corresponding memory locations 155, 156, 157. The arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 1B, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises: a fetch operation, which fetches or reads an instruction 131 from a memory location 128, 129, 130; a decode operation in which the control unit 139 determines which instruction has been fetched; and an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes described herein is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The method described herein may alternatively be implemented in dedicated hardware such as one or more integrated circuits performing the functions or sub functions. Such dedicated hardware may include graphic processors, digital signal processors, or one or more microprocessors and associated memories.

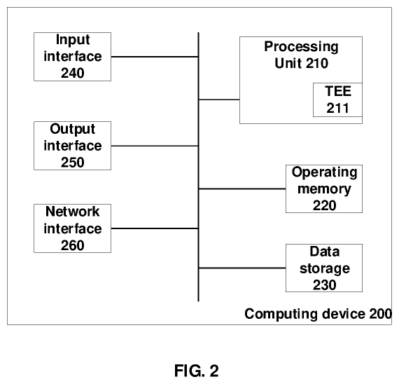

FIG. 2 illustrates an example of a computing device 200 with trusted execution environment (TEE) functionality. The computing device 200 of FIG. 2 can be used as a system node 310 as described herein. The computing device can be provided in the form of processing system 100 described in relation to FIG. 1, but additionally being provided with a TEE 211. The computing device 200 includes at least one block of operating memory 220, at least one data storage unit 230, at least one input interface 240, at least one output interface 250, and at least one network interface 260. Computing device 200 can be implemented as any kind of specific or generic-purpose computing device such as a server, virtual machine image, portable computer, laptop, TOT device, mobile phone, embedded device or the like.

The processing unit 210 includes components for providing the TEE 211. The TEE 211 is provided by processing unit functionality which is also referred to as a Secure Execution Environment, Security Trusted Execution Environment, Trusted Execution Technology, Software Guard Extensions, Platform Security Processor, or the like as may be referred by different hardware vendors and other institutions. The processing unit 210 is configured to execute instructions of computer code or programs that implement the described technology and associated components. The processing unit can include any generic or specific-purpose electronic processing circuit such as central processing unit, microprocessor, integrated processor, a field-programmable gate array, a programmable logic device, or the like.

Operating memory 220 refers to hardware integrated circuits used to store information, such as random-access memory, flash memory, or other memory technologies, and to work in conjunction with the processing unit 210. In some implementations, it can be an integrated portion of the processing unit 210.

Data storage 230 refers to any kind of storage device implemented on the computing device 200 and used to store computing data such as computing instructions, operating system images, and other components.

Input interface 240 provides an interface to receive inputs from system operators, users, or other devices. Output device 250 provides an interface to provide output from computing device 200 in a digital form. In some examples, the output interface 240 can be implemented as a graphical display presenting information to users and operators of the system.

Network interface 260 is configured to communicate with other systems by means of standard network communication protocols. Network interface 260 may be implemented as a wired network controller such as Ethernet, or a wireless network controller such as Wi-Fi, a close proximity network controller such as IEEE 802.15.4 or Bluetooth, or a mobile communication controller such as 3G, 4G, 5G, and LTE.

In some embodiments, some of these components can be integrated into other components. In some embodiments, the computing device 200 can be implemented as an integrated appliance with multiple components integrated into a single physical component, or a set of physical components. In some embodiments, the computing device 200 can be implemented with the use of virtualisation technology, where TEE functions will be provided to the host system through an underlying hypervisor layer with support of the TEE functionality provided through the TEE 211.

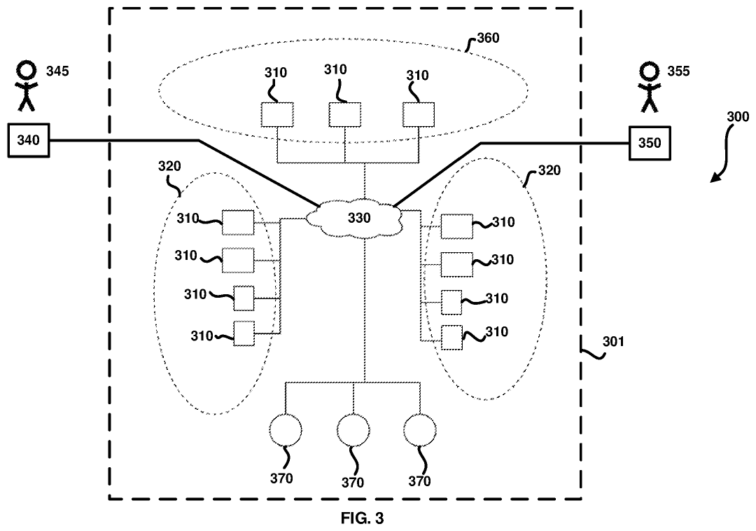

Referring to FIG. 3 there is shown a block diagram representing a system 300 for performing data transactions upon a dataset associated with a data owner.

In particular, the system 300 includes a transaction system 301 including one or more system nodes 310 forming a service network 320, in communication, via one or more networks 330, with a data owner processing system 340 and a data receiver processing system 350. Each system node 310 can be provided in the form of the computing device 300. The data owner processing system 340 and a data receiver processing system 350, which are referred to as ‘clients’ throughout this document, can be provided in the form of processing system 100. The system 300 includes a plurality of system nodes 310 forming a consortium network 360, wherein the service network 320 is a portion of the consortium network 360. The system 300 can include one or more attribute authority processing system 370 which are in communication with the one or more system nodes 310 of the service network 320 via network 330. The one or more attribute authority processing systems 370 can be provided in the form of one or more processing systems 100.

In one particular form, a data owner 345 is associated with the data owner processing system 340, and a data receiver 355 is associated with the data receiver processing system 350. The data owner 345 refers to an illustrative generic representation of an entity generating any identity-centric data in the context of the system 300. The data owner 345 can be an individual person, legal entity, an organisation, or a consortium of organisations. The data receiver 355 refers to an illustrative generic representation of an entity receiving any identity-centric data in the context of the system 300. The data receiver 355 can be an individual person, legal entity, an organisation, or a consortium of organisations.

The network 330 is an illustrative schematic representation of a computer network presenting a basic communication layer between the plurality of computing devices mentioned above as well as other parties. The network 330 may include a single or multiple networks implemented with wired network technologies such as Ethernet, or wireless network technologies such as Wi-Fi, a close proximity network controller as IEEE 802.15.4 or Bluetooth™, or a mobile communication controller such as 3G, 4G, 5G, and LTE, or other networking technologies. The network 330 may be composed of single or multiple network devices which can be implemented as any kind of specific or generic-purpose network device, such as a switch, router, gateway, computer, or other device implementing networking functions.

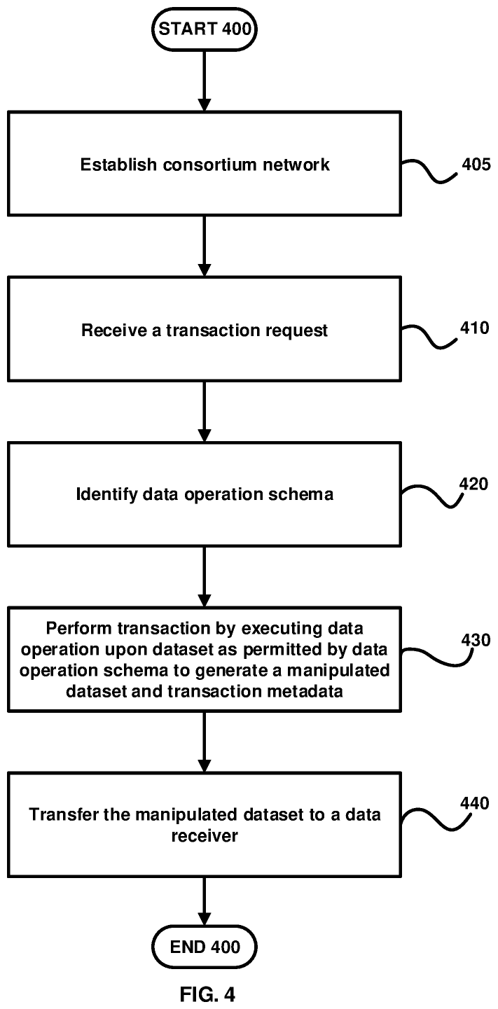

Referring to FIG. 4 there is shown a flowchart representing a method 400 for performing a transaction in relation to an identity centric dataset associated with a data owner. The method will be described in relation to the system 300 described above in relation to FIG. 3.

At step 405, the method 400 includes establishing, by a consortium network, a set of permitted data operations for a service network 320 using a plurality of privacy schemas.

At step 410, the method 400 includes receiving, by the service network 320, a transaction request to perform the transaction in relation to the identity centric dataset associated with a data owner 345.

At step 420, the method 400 includes identifying, by the service network 320 from the plurality of schemas and based on the transaction request, a privacy schema from the plurality of privacy schemas for use in performing the transaction.

At step 430, the method 400 includes performing the transaction by executing, in a trusted execution environment of the service network 320, one or more data operations from the set of permitted data operations upon the identity centric dataset of the data owner as permitted by the identified privacy schema, thereby generating a manipulated dataset and transaction metadata.

In step 440, the method 400 includes recording the transaction metadata to a distributed ledger of the service network 320.

In step 450, the method includes transferring the manipulated dataset to a data receiver indicated by the transaction request.

The system 300 and method 400 provide a configurable mechanism to establish, enforce and audit privacy-focused policies for identity-centric services. In some scenarios, a consortium of multiple parties is able to define rules in relation to how identity-centric transactions can be managed within their environments. In some implementations, the consortium is able to define permitted operations for certain dataset categories, based on configuration parameters defined by the consortium such as user consent, transaction context, data owner group membership, data receiver group membership, and other parameters. These rules can be configured by the system in the form of privacy schemas. For example, the consortium may decide to define a specific privacy schema that can enforce a specific privacy contract to one or more specific transaction types, defined by whom the dataset is being disclosed thereto (data receiver membership). While a full disclosure may be permitted for some data receivers (e.g. trusted parties such as government authorities), one or more selective disclosure mechanisms may be employed for other data receivers (e.g. 3rd party data brokers). In this way, the system 300 and method 400 provide consortium-regulated enforcement of the established privacy and consent policies, as data owners are only be able to transact their data within the boundaries defined by the defined policies.

The system 300 and method 400, as well as the methods and systems disclosed herein, enable the establishment of a trusted environment across a network, the definition of privacy policies in terms of smart contracts on the network, and the maintenance of an established trust relationship whilst providing services to other parties which might be generating private data transactions and confidential datasets.

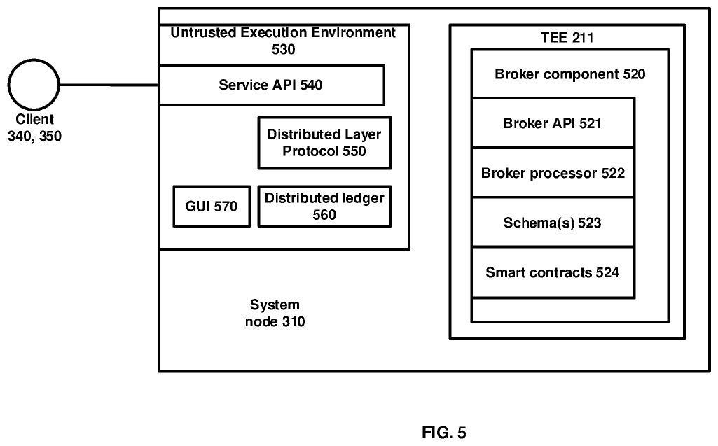

Furthermore, the system 300 and method 400, as well as the methods and systems disclosed herein, enable the establishment of an identity-centric distributed ledger network with strong confidentiality and privacy purposes. Furthermore, the system 300 and method 400, as well as the methods and systems disclosed herein, disclosed herein enable processing of identity-centric transactions on such a network. system 300 and method 400, as well as the methods and systems disclosed herein, provides privacy-preserved data processing capabilities through a broker component 520 (see FIG. 5), as discussed herein, which is implemented by one or more system nodes 310 of the service network 320. The broker component 520 (see FIG. 5) serves as a decentralised data security layer, providing decentralised data processing services such as encryption, privacy preservation and anonymisation.

Referring back to FIG. 3, the consortium network 360 is formed by one or more system nodes 310 configured as consortium network members. The clients 340, 350 utilise services provided by service networks 320. The attribute authority data systems store authoritative records for identity attributes (e.g. a government authority having access to authentic birth records).

In some implementations, the one or more of the system nodes 310 are provided in the form of a hardware or a software appliance configured for various roles within the system 300. In some implementations, one or more of the system nodes 310 can be configured as a member on the consortium network 360. In some implementations, one or more of the system nodes 310 can be configured as a member on the service network 320. In some implementations, some of the system nodes 310 can be configured for both of these roles. In some implementations, one or more system nodes 310 can be configured to operate on multiple networks, while performing different roles on different networks. In one example, one particular system node 310 can be configured as a member on one consortium network 360, while at the same time the same particular system node 310 can also be configured as a member on another consortium network 360.

The consortium network 360 is formed by one or many system nodes 310 configured as members of the respective consortium network 360. The consortium network 360 can be implemented as a distributed ledger network with the use of various distributed ledger technologies. In some implementations, the consortium network 360 can be implemented as a private permissioned distributed ledger network.

Each service network 320 is formed by one or more of the system nodes 310 configured as members of the respective service network 320. Each service network 320 can also include one or more clients 350. Each service network 320 can be implemented as a distributed ledger network with the use of various distributed ledger technologies. In some implementations, the service network 320 can be implemented as a private permissioned distributed ledger network.

Each client 350 is any computer device 100 connected to the service network 320 of the one or more system nodes 310 through the service API. Each client 350 can be implemented as any generic or specific purpose computing device such as processing system 100, such as server, virtual machine image, portable computer, laptop, embedded device, mobile device, IoT device, or the like.

Each attribute authority 360 is a party storing authoritative records for identity attributes. In some implementations, a data store of the one or more attribute authorities 360 can be implemented in the form of as a database, a public key infrastructure system, or any other generic data store capable of storing one or more identity attributes.

Referring to FIG. 5 there is shown an example of a plurality of computer program modules executable by one of the system nodes 310. Each system node 310 comprises a TEE 211, a broker component 520 provided in the form of a privacy and consent broker component 520 running within the TEE 211, a broker API 521 implemented which can be implemented in the form of a privacy and consent broker API 521, a broker processor 522 which can be implemented in the form of a privacy and consent broker processor 522, one or more schemas 523 which can be implemented in the form of one or more privacy schemas 523 and one or more smart contracts 524 which can be implemented in the form of one or more privacy contracts 524. Each system node 310 also includes an untrusted execution environment representing a standard execution environment outside of the TEE 211, a service API 540, a distributed ledger protocol module 550 utilising a distributed ledger protocol, an identity ledger 560, and a GUI 570 for user-friendly management of the components of the system 300.

The TEE 211 allows establishment of a secure enclave within the processing unit 210, providing cryptographic protection for the executed instructions and the associated memory regions, as well as providing confidentiality and integrity for executed instructions. The TEE 211 establishes a special trusted execution context where trusted instructions can be executed. The context is isolated from the untrusted execution environment 530. The untrusted execution environment 530 represents standard execution environment in context of an operating system. Anything outside of the TEE 211 is seen as untrusted, while execution within the TEE 211 is referred to as secure and trusted. In some implementations, the TEE 211 can be used to reliably scale the system and to build trusted computational extensions to the system (sometimes referred as side-chains) to provide for high speed distributed trusted computation across the system. The TEE 211 is cryptographically linked to the consortium layer through a remote attestation process. In some implementations, the transactions within the TEE 211 are encrypted, and the decryption key can only be available within the TEE context and not accessible from the untrusted execution environment 530.

The TEE 211 hosts a number of functions and processes facilitating operation of the privacy and consent broker 520. In some examples, implemented functions and processes can include secure bootstrap and system initialization, integrity management for system executables, remote attestation to the consortium network 360, leading configuration from the consortium network 360, loading privacy contracts 524 from the consortium network 360, loading privacy schemas 523 from the consortium network 360, executing privacy contract(s) 524, and providing transaction validation.

The privacy and consent broker 520 is designed to execute basic data operations within the system 300. In the illustrative representation of the system node 310, the privacy and consent broker 520 is configured to perform processing of privacy contracts 524 and production of the manipulated dataset which preferably is a privacy preserved dataset.

The privacy and consent broker API 521 provides an application programming interface for other components of the system 300 to call particular functions of the privacy and consent broker 520.

The privacy and consent broker processor 522 can support various data operations, such as data transformation, data encryption, data privacy preservation, data anonymization, data pseudo-anonymization, data tokenization, data enrichment with transaction metadata, assign data labels based on the consortium-based policies, and assign data classification labels and data dissemination markers based on the consortium-based policies. These operations can be encoded in privacy contracts 524, as a single operation, a plurality of operations, or any other complex logic using these operations. The privacy and consent broker 520 provides confidential execution of basic data operations, cryptographically linked to policies and rules set by consortium network 360.

Data processing rules are defined in the one or more privacy schemas 523 which set criteria on the types of data that can be processed by any particular privacy contract 524, as well as defining identity attributes and metadata that are to be attached to a resulting manipulated dataset.

The service API 540 provides an application programming interface for external clients 340, 350.

The distributed ledger protocol module 550 can be implemented using a private blockchain-implemented system. For example, the distributed protocol module 550 can be implemented as a Hyperledger system (see https://www.hyperledger.org/). However, it will be appreciated that other forms of distributed ledger protocol systems can be used. In some implementations, the distributed ledger protocol module 550 supports execution of a distributed ledger transaction, and can be configured to execute certain consensus algorithm on the network. The distributed ledger protocol module 550 maintains the distributed ledger 560 to record the current state of the distributed ledger network.

In some implementations, the system node 310 can provide a graphical interface GUI 570 used to operate system node 310 components and provide data output. In some implementations, the GUI 570 can provide a user interface guiding a user through an on-boarding process for a system node 310, such as providing details on protocols and methods that can be used, networks that are available upon membership, and policies (i.e. privacy contracts 524) that can be configured on the network. In some implementations, the user will be able to inspect the list of consortium network nodes and consortium network policies, and select certain nodes 310 and certain contracts 524 to be used on an any particular network. In some implementations, the GUI 570 can guide the user through a variety of use cases proposed by the system, allowing system customisation based on a specific use case. In some implementations, the GUI 570 can provide an identity integration and enrolment service, allowing users to enroll identities and identity attributes as part of the network establishment. In some implementations, a user will be able to create identity profiles and set identity attributes associated with these profiles to be used on the network. In some implementations, a user will be able to modify configurations of the nodes 310 and privacy contracts 524, and save the contracts 524 to the network. The contracts 524 can be signed by the attribute authorities, or can be published as non-signed templates/schemas 523.

In one implementation, the described methods for system node initialisation and network establishment utilise the distributed ledger technology also known as ‘blockchain’. The methods are implemented as part of a system node 310, and provide functionality for the establishment of identity-centric distributed ledger network with strong confidentiality and privacy purposes, as well as for initial configuration of the privacy and consent broker 520 with the network-specific parameters used for identity-centric data processing.

As the first step of the system initialisation, a consortium network 360 is defined. In some implementations, the consortium network 360 is formed by one or more system nodes 310 configured as members of the particular consortium network 360. In some implementations, the consortium network 360 is implemented through the use of the distributed ledger technology, where multiple trusted parties, or consortiums formed by multiple trusted parties, replace a trusted third party for the initial onboarding onto the network.

The consortium network 360 can be defined as a distributed network sharing the same policies. A consortium network 360 is configured for remote attestation of system nodes 310 with the use of asymmetric cryptography. In other words, the consortium network 360 is implemented for cryptographically strong authentication and integrity verification of participating system nodes 310. The consortium network 360 represents a pre-established consortium of members which are set as authoritative parties of the respective distributed ledger network.

The identity ledger serves as a distributed configuration of the state of the system 300. An instance of an identity ledger is defined for each consortium network 360, and replicated between all member system nodes 310 by means of a selected distributed ledger protocol 550. The identity ledger records consortium configuration parameters which are defined for each consortium network 360. These configuration parameters are stored on each of the system nodes 310 in the consortium network 360 and recorded in the distributed ledger as the current consortium network configuration state. Any system node 310 joining the network also receives a copy of all configuration parameters, following the successful attestation.

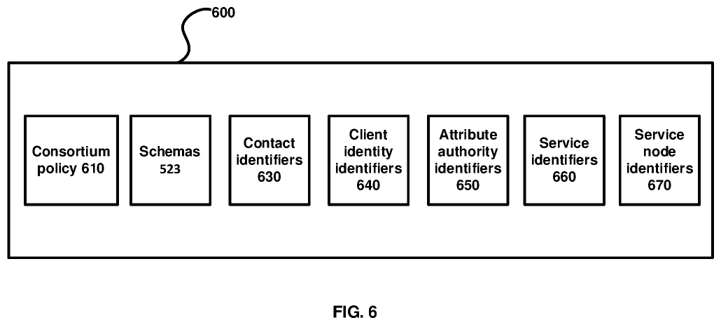

Referring to FIG. 6 there is shown is an example of an identity ledger 600 implemented on system nodes 310 forming the consortium network 360. The identity ledger 600 is a distributed ledger 560 which is used as part of the configuration of a system node 310 when established as a member of the consortium network 360. The identity ledger 600 includes multiple configuration parameters, which in some implementations can include a consortium policy 610, one or more privacy schemas 523, one or more privacy contract identifiers 630, one or more client identity identifiers 640, one or more attribute authority identifiers 650, one or more service network identifiers 660, and one or more service node identifiers 670. The configuration parameters can be recorded on the identity ledger 600. In case of any changes in the composition of a consortium network 360, the updated configuration parameters can be appended to the identity ledger 600. All system nodes 310 can be configured with reference the latest records on the identity ledger 600 representing the latest instance of the configuration state.

In some implementations, the identity ledger 600 can include a current version of the consortium policy 610 published by this particular consortium of members, one or more current versions of the one or more privacy schemas 523 published by the respective particular consortium of members, one or more current privacy contract identifiers 630 of one or more current privacy contracts 524 published by the respective consortium of members, one or more current client identity identifiers 640 for all data owners, data receivers, and other parties consuming system services, current list of all attribute authority identifiers 650 published by the respective consortium of members, a current list of all service identifiers 660 published by the respective consortium of members, a current list of all service node identifiers 670 attested by the respective consortium of members.

The consortium policy 610 defines configuration of the consortium network 360 and defines governance rules which are agreed between all system nodes 310 on the consortium network 360. The consortium policy 610 defines business logic for the consensus algorithm in the consortium network 360. In some implementations, the consortium policy 610 can be encoded by means of smart contracts 524 on the network, using smart contract execution procedures of a standard distributed ledger network.

In some implementations, the consortium policy 610 can include a current list of all system nodes 310 which are part of the consortium network 360, a current list of all smart contracts 524 defining rules for system nodes 310 to join the consortium network 360, a current list of all smart contracts 524 defining rules for providing attestations to system nodes 310, a current list of all smart contracts 524 defining rules for any modifications in the configuration of the consortium network 360, and a current list of all smart contracts 524 defining rules for adding new services, modifying services, and deleting services from the system.

Most of the identity data within the system 300 is represented in the form of identity attributes, which can be described as individual properties associated with any particular composition of an identity information. Identity attributes are owned by one or more authoritative issuers which within the context of the system 300 are described as one or more attribute authorities. Attribute authorities store identity attributes as authoritative records within one or more authority networks, and can provide verified data in relation to these attributes to identity owners and to other parties.

Identity authorities can define and publish one or more privacy schemas 523, and configure certain consent and privacy properties as part of one or more defined privacy schemas 523. The one or more privacy schemas 523 are applied during data operation executed by the privacy and consent broker component 520. For example, the one or more privacy schemas are applied as part of any transactions associated with selective disclosure of any particular identity centric dataset. The one or more privacy schemas 523 define metadata parameters which characterise how any particular identity attribute (or information associated with this attribute) can be used, and should be used.

In some implementations, the one or more attribute authorities are responsible for the origination of identity assertions used for a disclosure of any particular identity attributes. The proposed privacy and consent broker 520 operates to establish a trust relationship between a data owner, associated identity attributes, data transaction, and a data receiver through the use of the privacy schemas 523 and privacy contracts 524.

In some implementations, attribute authorities can cryptographically bind trusted execution of privacy contracts 524 in the TEE 211 on system nodes 310 to specific identity attributes and associated privacy schemas 523.

The service network 320 can be defined as a collection of system nodes 310 configured as members for the respective service network 320, as well as associated privacy contracts 524 and associated privacy schemas 523 configured for any particular purpose. Usually the service network 320 is implemented to enable a specific use case of a system 300 as later discussed herein.

Service network configuration is managed by the consortium network 360. Each consortium network 360 can have multiple services, and some system nodes 310 can be configured to run multiple services. Service network configuration is managed through an authorisation process similar to the attestation process used during consortium network initialisation. As the service configuration is defined at a consortium network level, member nodes 310 are able to initiate join requests for the respective service. Join requests are processed by the consortium network 360 and based on the configured policies, authorisation can be provided to a member system node 310, allowing the respective system node 310 to run the service. Each service network 320 includes a number of system nodes 310 which are authorised for this particular service by the consortium network 360 and therefore can be defined as service nodes 310 for the respective service.

In some implementations, system nodes 310 configured as service nodes 310 provide service-specific functionality, and embed service-specific API functions and service-specific privacy contracts 524 and privacy schemas 523, as defined and published by the consortium network 360 for the respective service. In some implementations, service nodes 310 can run multiple services.

In some implementations, private services can be defined by any subset of nodes 310 of the system 300. The nodes 310 implementing private services can establish their own consortium network 360, based on the processes described within this document, and define their own consortium policies, privacy contracts 524 and privacy schemas 523. In this case, these configuration properties will not be attested by the genesis consortium network, and operate as a private consortium as agreed by this particular subset of service nodes. In some implementations, these service nodes are able to create new services, provide attestations for the newly formed consortium network 360, and publish privacy contracts 524 and privacy schemas 523 attested by the newly formed consortium network 360.

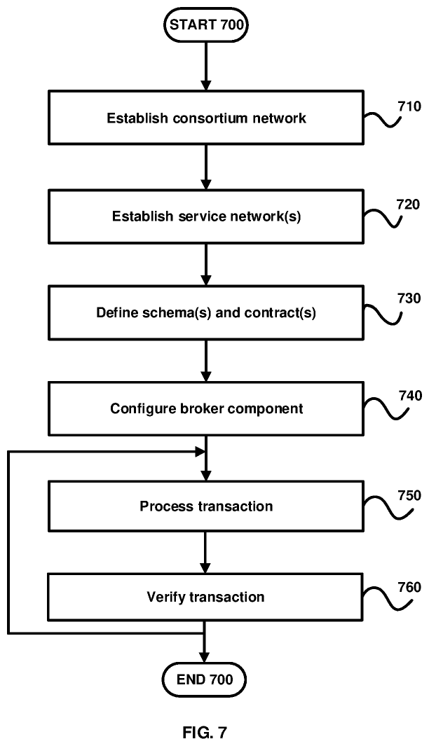

FIG. 7 is a flowchart illustrating an example method including system initialization and transaction processing.

At step 710, a consortium network 360 of system nodes 310 is established and consortium network configuration parameters are encoded in the consortium policy 610. In some implementations, one or more processes associated with consortium network 360 are established, such as consortium network initialization, creation of a new consortium network, joining an existing consortium network 360, and modifying an existing service network 320.

At step 720, one or more service networks 320 are established. In some implementations, establishing one or more service networks 320 includes creating a new service network 320, joining an existing service network 320, and modifying an existing service network 320.

At step 730, one or more privacy schemas 523 and one or more privacy contracts 524 can be defined for the service network 320. In some implementations, the definition process can include one or more attribute authorities creating identity attributes and recording these identity attributes on their network, creating privacy schemas 523 which define how these identity attributes can be used, including sharing, consent, and other properties, and/or creating privacy contracts 524 which define how transactions are processed and how resulting datasets are generated.

At step 740, the privacy and consent broker components 520 of system nodes 310 are configured with the defined privacy contracts 524 and privacy schemas 523. In some implementations, each privacy and consent broker 520 is configured to accept any data transactions which satisfy network policy requirements set through privacy schemas 523 and privacy contracts 524.

At step 750, clients 340, 350 transfer, to the service network 320, a data transaction request. In some implementations, these transaction requests are produced by data owners and addressed to a data receiver, or a group of data receivers. In some implementations, these transactions are associated with identity identifiers assigned to clients, and identity attributes assigned to these identifiers. In some implementations, at step 750 the consent and privacy broker 520 performs data operations, and appends metadata to transactions. In one example, metadata properties such as consent and context are recorded in way of a hashed and signed record on the service network distributed ledger.

At step 760, resulting records can be used later for verification of any particular transaction, and can be verified by any of the involved parties.

As part of this configuration process, consortium members agree on certain aspects of identity management and identity attribute management, for example what identity attributes are recorded on the distributed ledger, how identity-centric transactions are defined, configuration ranges for metadata parameters, and services provided by a consortium network 360.

Various techniques can be used to determine an initial configuration of a consortium network 360. In some implementations, initial consortium rules can be determined manually by consortium members and encoded manually as part of a consortium network configuration.

In some implementations, the first node 310 on the network can initiate a genesis configuration request, providing description of the consortium network parameters. All subsequent nodes can be required to accept the proposed consortium network parameters, and can be required to agree on any subsequent changes to the consortium network parameters. For any subsequent nodes, the initialisation process can involve an attestation of the subsequent node through the consortium network 360. The resulting attestation transaction can be recorded on the consortium network identity ledger. In some implementations, the attestation transaction can be identified through digital signatures produced by all attesting parties of the consortium network 360. The resulting transaction can be used at any point of time to verify identity and membership of any particular system node 310, as well as to establish the trusted chain of provenance as to how the attestation and resulting membership was obtained. In one form, an example of configuring a consortium network 360 is described by US Patent Application Publication No. 20180227275 which is herein incorporated by reference in its entirety.

Through the initialization process, every system node 310 of a consortium network 360 is validated and attested by other system nodes 310. System nodes 310 on the consortium network 360 can publish identifiers of all attested system nodes 310 on the consortium network identity ledger. The TEE 211 of each system node 310 is used to facilitate node validation and attestation processes on any particular system node 310. As the attestation process is successful, the network is extended such that the attested system node 310 becomes a fully functioning node 310 of the network.

Consortium configuration parameters are recorded to instances of the identity ledger configured on all member system nodes 310. These configuration parameters are stored on each of the system nodes 310 in the consortium network 360 and managed by a selected distributed ledger protocol. Any subsequent node 310 joining the network also receives a copy of all configuration parameters, following successful attestation.

In one example, consortium network configuration state can be defined as a combination of configuration parameters such as consortium network policy 610, a list of one or more member nodes 310 of the consortium network 360, a list of one or more attribute authorities of the consortium network 360, a list of one or more privacy schemas 523 of the consortium network 360, a list of one or more privacy contracts 524 of the consortium network 360, and/or a list of services of the consortium network 360.

After the initial configuration state is defined, the configured parameters are encoded in the respective TEE 211 of each attested system node 310, and privacy and consent broker components 520 of all attested system nodes 310 are activated and populated with corresponding instructions.

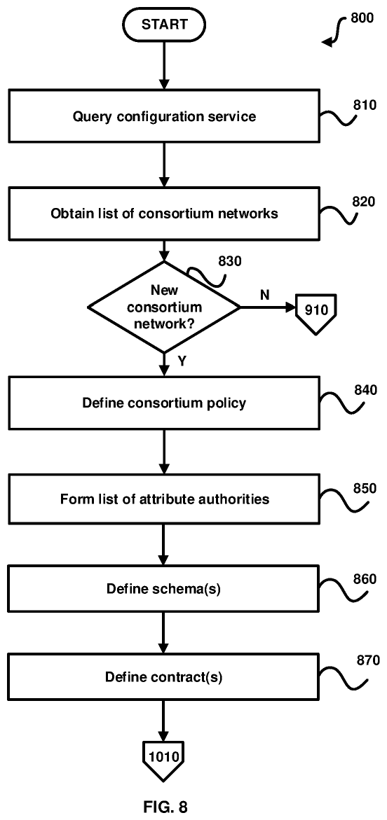

Referring to FIGS. 8, 9 and 10 there is shown a flow diagram representing an example system initialisation method.

In this example, FIG. 8 illustrates initial steps of a method 800 performed by a system node 310 to define a consortium network 360. In some implementations, an external configuration service can be used to provide a list of all existing consortium networks 360.

In this illustrative process, at step 810 a system node 310 is provided with the current list of all existing consortium networks 360.

At step 820, a current list of all consortium networks 360 is obtained.

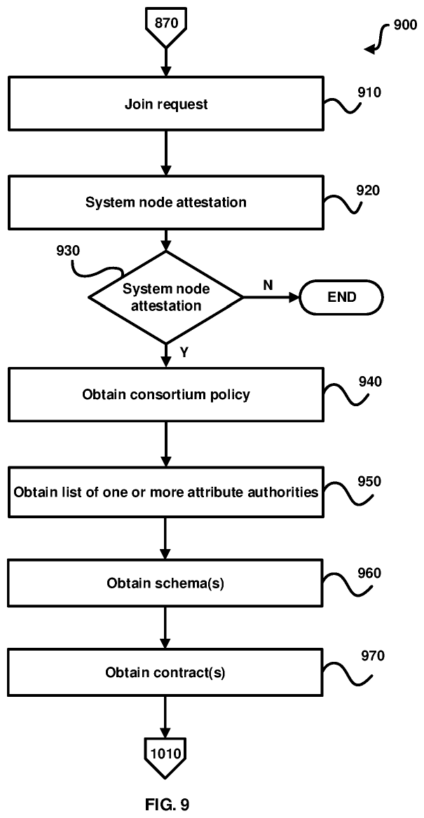

At step 830, the system node 310 can determine whether it joins an existing consortium network 360 (NO—proceed to step 910 of FIG. 9), or forms a new consortium network 360 (YES—proceed to step 840). The determination can be made via a guided user configuration process, automated deployment process, or by any other means.

At step 840, a consortium policy 610 is defined and configured.

At step 850, a list of attribute authorities is formed and configured.

At step 860, privacy schemas 523 are defined and configured.

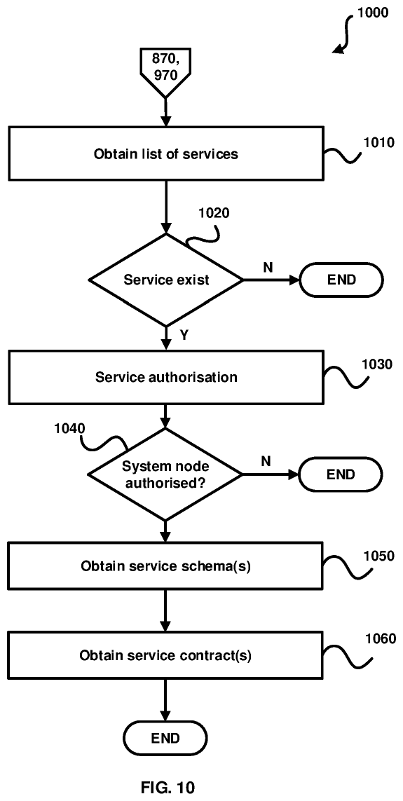

At step 870, privacy contracts 524 are defined and configured. The method then proceeds to step 1010 of FIG. 10.

Referring to FIG. 9 there is shown a flowchart representing a method 900 of a system node 310 joining an existing consortium network 360.

In particular, at step 910 a system node 310 sends a join request to the existing consortium network 360.

At step 920, the system node 310 is attested by consortium network 360. In some implementations, a join request can include an identifier of the requesting system node 310. The system node identifier is cryptographically verified by the consortium network 360, with attestation being successful if the system node 310 is able to confirm its identity by producing a verifiable digital signature during the join request process. The process involves signing a cryptographic challenge issued by the consortium network 360. As a consortium network 360 represents a distributed system, the attestation is not processed by a single node 310, but rather is implemented as a distributed transaction on the consortium network 360, triggering the distributed ledger consensus rules defined by the respective consortium of members. In some implementations, based on the consensus protocol, attestation may involve attestation of requesting node 310 by one or more parties. The method can further include recording a transaction with multiple signatures representing the attesting parties which validated the transaction.

In some implementations, at decision step 930 the method includes determining if the system node 310 was attested. In the event that the system node 310 was not attested, the process terminates (NO). In the event that the system node 310 was attested, the process continues (YES) to step 940.

At steps 940 to 970 the system node 310 joins the consortium network 360. The system node 310 becomes a member of the distributed consortium network 360, and obtains a copy of the identity ledger from the consortium network 360. The system node 310 also receives configuration parameters from the consortium network 360, including the configured one or more privacy schemas 523 and one or more privacy contracts 524. The system node configuration parameters are obtained from the identity ledger. This process is implemented using the selected distributed ledger protocol.

At step 940, the system node 310 obtains the consortium policy 610.

At step 950, the system node 310 obtains list of one or more attribute authorities.

At step 960, the system node 310 obtains the one or more privacy schemas 523.

At step 970, the system node 310 obtains the one or more privacy contracts 524. The method 900 proceeds to step 1010 of FIG. 10.

Referring FIG. 10 there is illustrated a flowchart representing a process 1000 for a system node 310 of the consortium network 360 attempting to join a service network 320.

At step 1010, the system node 310 obtains a list of services from the consortium network 360.

At decision step 1020, a determination is made as to whether a required service exists on the list. If the service does not exist or cannot be selected, the process terminates (NO). If the service can be selected, the process continues to step 1030.

At step 1030, the system node 310 is authorised for the respective policy 610. The authorisation process can be guided by a configured consortium policy 610 of the consortium network 360, or processed manually.

At decision step 1040, a determination is made as to whether authorisation was obtained. If authorisation was not obtained, the process terminates (NO). If authorisation was obtained, the process continues to step 1050.

At step 1050, one or more service-specific privacy schemas 523 are obtained.

At step 1060, one or more service-specific privacy contracts 524 are obtained.

As the system node 310 becomes a member of the service network 320, the respective privacy and consent broker 520 is initialised and receives access to the trusted execution of the privacy contracts 524 through the respective TEE 211.

In some implementations, system nodes 310 can form private trusted execution channels, and define privacy schemas 523 and privacy contracts 524 independently of the established consortium network 360. Such private services can be defined by any subset of system nodes 310 on the network. In one example, some system nodes 310 can establish their own consortium network 360, based on the processes described within this document, and define their own consortium policies, privacy contracts 524 and privacy schemas 523. In this case, these configuration properties will not be attested by the genesis consortium network, and will operate as a private consortium as agreed by the respective subset of service nodes. In some implementations, these service nodes are able to create new services, provide attestations for the newly formed consortium network 360, and publish privacy contracts 524 and privacy schemas 523 attested by the newly formed consortium network 360.

In one example, a system node 310 can create a privacy contract 524 which can be used to transact with any other system node 310, or group of system nodes 310. In this example, in case a system node 310 is not willing to disclose privacy contracts 524 to any other members of the network, the system node 310 can build a private service network by initiating another instance of the TEE 211 on participating system nodes 310. In this way, participating system nodes 310 can define private business logic in terms of privacy contracts 524, and process data based on newly defined privacy schemas 523 and privacy contracts 524.

As part of the privacy and consent broker operations, all data transactions are processed by the privacy and consent broker component 520 running in the TEE 211. All data associated with identity attributes can be confidentially processed within the TEE 211 as part of a privacy contract execution.

The TEE 211 of each system node 310 of the network is configured with privacy and consent broker software instructions. Based on a system node membership, the privacy and consent broker 520 of each system node 310 is configured with privacy schemas 523 and privacy contracts 524 for any particular service that the system node 310 has joined. The privacy and consent broker 520 of the system node 310 is configured based on predetermined privacy preservation and other data processing policies (such as data encryption, data privacy preservation, tokenisation, pseudo-anonymisation, and/or anonymisation) defined in privacy contracts 524. Privacy and consent broker 520 is configured to inspect incoming data transaction requests, and identify a particular privacy and consent schema 523 based on the incoming privacy attributes. Privacy schemas 523 are selected based on the identity of a client generating the transaction (i.e. the data owner 345), on the identity of a client receiving the resulting dataset (i.e. the data receiver 355) as well as on other metadata parameters, such a transaction context as well as a provided explicit consent from a data owner 345. The transaction metadata can represent transaction properties such as context, consent, data owner, data receiver, protocol, and other properties which may be different in some implementations. Private contract execution is performed. For private contract execution, a trusted cryptographic channel is established to execute instructions locally as attested by the TEE module 211 on the node 310. As the execution results are received, the transaction metadata is recorded to the distributed ledger on the service network 320. A number of cryptographic hashes are calculated to ensure that the integrity and privacy of the transaction data and metadata is preserved. The transaction is committed to other service nodes 310 on the same service network 320. In some implementations, other service nodes can inspect the private contract code and can validate the results of computation and verify that the instructions are executed correctly.

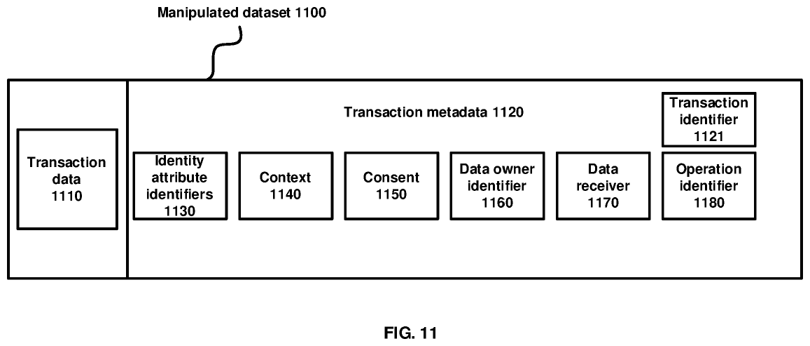

Referring to FIG. 11 there is shown an example of an illustrative privacy-preserved dataset 1100 produced by a system node 310 as the result of one or more data operations. In some implementations, resulting datasets can include one or more transaction data records 1110 produced by a client, one or more transaction metadata records 1120 produced by a client, one or more metadata records produced by a client including identity attribute identifiers 1130 for used identity attributes, one or more metadata records produced by a client identifying transaction context 1140, one or more metadata records produced by a client identifying consent 1150 attached to the dataset by a client, one or more metadata records produced by a client in a form of pre-defined identifier of a client or a data owner identifier 1160, one or more metadata records produced by a client in a form of pre-defined data receiver identifier 1170 of another party, a group of parties, or one or more data receivers, one or more metadata records produced by a client identifying operation identifier 1180 representing one or more data operations which were applied to the data set. In some implementations, data operations, could be implemented as encryption, anonymisation, pseudo-anonymisation, masking, or any other data processing operations, or any combination of data processing operations. The transaction metadata 1120 includes a transaction identifier 1121.

Transaction consent can be written, verbal, electronic or the like. The transaction consent is indicative of the data owner's permission to perform particular data operation on their private data, such as analysis, disclosure, retention, mining, correlation, or any other processing of the data. In the context of the described system and method, consent can be seen as an atomic metadata property of the identity-centric dataset. Consent can be an important factor for particular data transactions, as it represents a direct expression of an individual's privacy rights in relation to any particular data exchange or disclosure.

Any consent granted by a data owner is attested by the system 300 as per the defined privacy schemas 523 and privacy contracts 524 for any particular service and transaction type. With the disclosed system 300, consent can be attached to a dataset and then recorded on a service network 320, and then privacy contracts 524 can be executed based on the provided consent. In this way, the system 300 can guarantee that data processing does not violate data privacy, and therefore does not violate privacy rights of a data owner. Consent is not recorded as a simple binary choice, but rather is constructed as a part of transaction metadata based on privacy schemas 523 configured for any particular identity attributes. In some implementations, privacy contracts 524 may define to what extent services can interact with user datasets based on the provided consent. Privacy schemas 523, privacy contracts 524, rules and policies can be established to regulate how transaction properties are processed in the service network 320. While a user still has full control and full visibility of their data and associated data properties, the accountability lies with the service network 320, and can be easily inspected by a regulator as may be required. In some implementations, consent can be implemented as an immediate and recorded acceptance of terms of service within any particular transaction context. In some implementations, consent can be assigned in a privacy preserved manner, by means of a zero-knowledge proof technology. In this implementation, an anonymised consent is attached to an encrypted transaction and can be verified without identifying the data owner.

In some implementations, as a data owner provides consent for their data encryption, the encrypted dataset can be created and transmitted to the data receiver environment. In some examples where data encryption is implemented, privacy schemas 523 can define how encryption keys are distributed, creating more complex representation of consent and consent delegation. In one example, key escrow service can be included as a part of an encrypted transaction, ensuring that even while a user consents to share encryption keys to their data, they can always confidently revoke these keys without intervention from the data processor.

In some implementations, the system 300 can also be used to create more complex consent scenarios, where multiple parties might be providing mutual consent and authorisation to any particular transaction. In one example, some data transactions might require consents from various parties.

Transaction context is attached to resulting datasets. Transaction context is established whenever any data is received by the system 300 in a form of a transaction. In some implementations, transaction context defines what data can be processed, how it can be processed, and what properties can be extracted from the transaction. In some implementations, context metadata can be used to facilitate attribute-based encryption of a transaction. In one example, based on the context, attribute-based encryption can be applied to transactions. In one example, various contextual representations of any particular dataset, or any particular attribute, or any set of attributed, might generate various resulting datasets.

In some implementations, context-specific datasets can be created to enable context-specific proofing of identity attributes. In some implementations, unique identity presentations can be constructed based on context, and the ways identity presentations are created could be very contextual. In some examples, data owners might be able to construct various contextual identity representations based on their perception and understanding of privacy, or as it might be dictated by any other privacy requirements, for example based on published schemas 523 and contracts 524 from any particular identity attribute authority.

In some implementations, privacy schemas 523 are used to define how privacy-preserved datasets are generated from processed transactions. Privacy schemas 523 contain mappings of identity attributes corresponding to preconfigured methods of data processing (e.g. privacy contracts 524) associated with this particular privacy schema 523.

In some implementations, the defined mapping may include one or more rules defining mapping of the one or more identity attributes and metadata properties such as consent, context, processing method and other metadata properties into the resulting datasets.

In some implementations, privacy contracts 524 can be defined as execution instructions which are executed in the TEE 211 independently of untrusted execution. Privacy contracts 524 are dynamically loaded into the TEE 211 through the system initialisation process, and are not revealed to the unsecured environment of the system nodes 310. In some implementations, privacy contracts 524 are defined by attribute authorities for any particular identity attributes, or sets or identity attributes, and attested by the consortium network 360.

In some implementations, the TEE 211 is used to execute privacy contract instructions confidentially, in a way which will not disclose contract execution to system nodes 310 on the network. To enable private contract execution, TEE-powered trusted secret sharing can be implemented. Secret keys assigned to each of the system nodes 310 can be employed to create multi-key signatures and enable secure computation over the distributed ledger network. In some implementation, the TEE 211 can be used as a cryptographically secure storage and trusted processing environment where privacy contracts 524 are attested by the established consortium network 360 and then executed.

In some implementations, the system 300 can be used to perform basic data operations on datasets in accordance with configured rules (encoded as privacy contracts 524) defined by identity attribute authorities and attested by consortium members. In some implementations, consortium members can define privacy contracts 524 and provide attestations for these contracts 524.

In some implementations, the privacy and identity broker software running inside the TEE 211 can derive encryption keys accessible only to that system node 310, and provide attestations to other system nodes 310 based on a private contract execution logic. In this way, system nodes 310 can provide attestations to each other based on privacy contract execution results, without being able to inspect the data which was used for any particular contract execution.

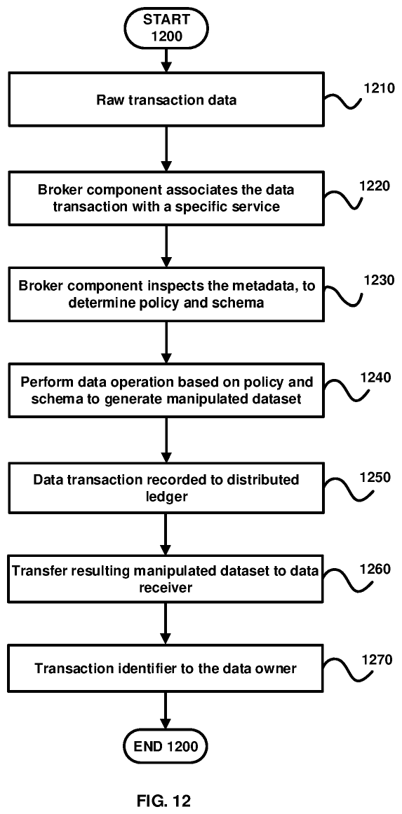

Referring to FIG. 12, there is shown a flowchart representing a method 1200 of operation by the privacy and consent broker component 520.

In particular, at step 1210 the method 1200 includes the privacy and consent broker accepting raw data transactions from a data owner (which can be described as, but not limited to, as a person possessing identity attributes, a computer or a device generating identity attributes on behalf of a person, such as an integrated or non-integrated IOT device).

At step 1220, the method 1200 includes the privacy and consent broker 520 associating the data transaction with a specific service.

At step 1230, the method 1200 includes the privacy and consent broker 520 inspecting the data transaction's metadata properties to match previously established privacy and consent policies defined by means of privacy schemas 523 and privacy contracts 524. At this step, metadata parameters are matches to defined privacy schemas 523, and in some implementations best-match logic can be used to select the most appropriate privacy schema 523 and associated privacy contracts 524.

At step 1240, based on the selected privacy schema 523 and privacy contracts 524, the method 1200 includes the privacy and consent broker 520 performing at least one of the following actions: data anonymisation, data encryption, tokenization, data enrichment with metadata, and eneration of verifiable credentials asserted by one or many attribute authorities.

At step 1250, the method 1200 includes the privacy and consent broker 520 recording the data transaction on the specific distributed ledger in a hashed format. cryptographic hash functions can be used to create anonymised on-chain data identifiers, which can be used later to reference to a certain data transaction.

At step 1260, the method 1200 includes the privacy and consent broker 520 delivering the resulting dataset to the data receiver.

At step 1270, the method 1200 includes the privacy and consent broker 520 sending the transaction identifier to the data owner.

In some implementations, some identity attributes can be presented as encrypted attributes which can be created as part of a privacy contract execution as it is defined by identity attribute issuers. Encryption, anonymisation, and privacy preservation can be set as a multi-party policy and be attested by multiple nominated parties rather than by a single authority. Individual identity presentations could be formed from a collection of these attributes. In one example, such identity presentations can be formed by a consortium of attribute authorities (“consortium-trusted” identity presentations, which will be co-signed by all consortium members). In one example, private identity representations can be formed by participating individuals (data owners), and can be made available to any parties who might be interested and motivated in verification of properties associated with these identity representations. An example of such an identity representation could be reputation accrued by an individual in a certain community of members.

In some implementations, a system node 310 can verify an identity of a client based on the business logic defined in privacy contracts 524, and request certain identity data from the client. The data transaction can be processed based on the configured privacy schemas 523 and privacy contracts 524 as provisioned by the consortium network 360, and can be delivered to the data receiver securely, including data provenance attributes, as well as providing privacy preservation for selected identity attributes.

In some implementations, a service API can also be referenced by a data receiver, for example in cases when access to encrypted data needs to be enabled and some datasets need to be decrypted.

In one example, the following process can be used:
a. a data receiver receives an encrypted message;
b. a data receiver creates a data access request by presenting required parameters (such as consent and context) matching the pre-configured privacy schema 523, as to satisfy the set access control criteria for the data; and
c. if the access control criteria are met, a private and consent broker 520 generates a decryption key which can be used by a data receiver to get access to the data, and records the data access event as a transaction, identifying transaction properties such as data owner, data receiver, transaction consent, transaction context, and data operation.

In some implementations, a privacy and consent broker component 520 can be configured to create multiple representations of data based on defined privacy schemas 523. Some data can be aggregated and presented in an aggregated form only, without disclosing original data from individual transactions.

In some implementations, a number of external distributed ledger nodes (belonging to different distributed ledger networks) can be implemented in containerised configurations within the system 300. In one example, the system 300 will provide secure data operations between the networks through the privacy and consent broker 520.

In some implementations, system nodes 310 can be configured to execute transactions on multiple networks. A privacy and consent broker 520 can be configured to securely create multiple service instances in the TEE 211, execute transactions, and if necessary, exchange privacy data between the networks. In some implementations, the transaction metadata properties, such as consent, context, data owner, data receiver, and other preconfigured properties, can be exchanged between the networks. In some implementations, the system 300 can be configured to execute atomic transactions, when a transaction can be committed at multiple networks only if it is validated on all of these networks. In some implementations, a privacy and consent broker 520 can be configured to apply basic data privacy preservation operations such as encryption, anonymisation, masking, and other operations, to any data transmitted between system nodes 310 on different networks. The operations will be executed in the Trusted Execution Environment as previously described.

In some implementations, an “oracle” service can be defined for privacy contracts 524, where external data can be used to influence execution of a privacy contract code. as well. In one example, an external party might be able to receive an identity identifier from the network, and will be able to communicate with the network by presenting the identifier which was previously verified by the network.

The system 300 can have various embodiments in relation to how identity data and identity attributes are encoded in the system 300. The system 300 can be used to process any identity-centric datasets, such as datasets associated with people identities, product identities, device identities, IoT device identities, supply chain components identities, and other use cases where physical or logical identifiers can be attached to any physical or virtual objects. Various methods can be used to obtain such identifiers.

The system 300 can provide for various data operations through the privacy and consent broker 520. In some implementations, the system 300 can tokenise the data and produce tokenised datasets. In some implementations, the system 300 can provide data encryption. In some implementations, the system 300 can provide data anonymisation and/or pseudonymisation. In some implementations, the system 300 can provide other data processing operations, or combinations of abovementioned operations, including abovementioned operations and any other data processing operations.

In some implementations, system nodes 310 can be also configured as IoT gateways, providing secure onboarding and authentication for IoT devices, as well as proving API for privacy-preserved data processing and further transmission of resulting datasets to data receivers. Various methods can be used to obtain identifiers of IoT devices. In some implementations, embedded secure elements can be used for device identification, and identities can be either encoded during device manufacturing, or obtained later through device onboarding process. In some implementations, product identities can be integrated into physical assets through the attachment of a physical tag or through an embedded secure element. An integrated tag or integrated secure element provides for a cryptographic identifier, which is being on-boarded to the system identity layer, and can be attested in the future to ensure the authenticity of the asset. In some implementations, any data generated on IoT devices, as well as any transactions produced by the devices, can be processed by the system trusted computation layer dictated by policies set by any particular identity attribute authority in a form of privacy schemas 523 and privacy contracts 524.

In some implementations, the system 300 can be used for privacy-preserved IoT regulation purposes, when regulating authorities can be trusted to attest current states of IoT devices (for example, a health industry regulator would verify authenticity and integrity of health IoT), but will not be able to inspect the data generated by the device.

In some implementations, the system 300 can be used in supply chain management and asset management systems, when crypto tags can be attached to goods and assets at manufacturing or logistics stage. The crypto tags can be pre-registered at the network identity ledger, and uniquely identify any particular product or asset. In some implementations, product identities of all individual components manufactured at various stages of the supply chain will be added to the identity network.

In some implementations, the graphical user interface may be configured to display data owner data transactions, data consent transactions, and data sharing transactions, as well as associated metadata, such as:

a. Display information on the encrypted data

b. Display information on the privacy-protected data

c. Display information on the anonymised data

d. Display information on the pseudo-anonymised data.

In some implementations, the system 300 can be used as a component of a cyber security threat detection, such as security operations, fraud prevention, and security intelligence gathering. A user and entity (IoT) data can be received by the system 300, anonymised, and used to build user or entity profiles, feed into various machine learning and prediction algorithms.

One example use case for the system 300 will now be described. The use case relates to the use of the system 300 for an implementation of a digital citizen identity system, and in particular a digital driving license system. In a digital citizen identity system, a number of government departments can form a consortium of members, regulating certain aspects of how citizen identities are created, issued and presented.

The system 300 provides configurable mechanisms to establish, enforce and audit privacy-focused policies for identity-centric citizen services. In some scenarios, a consortium of multiple parties define rules as of how identity-centric transactions can be managed within their environments. In some implementations, the consortium define permitted operations for certain dataset categories, based on configuration parameters defined by the consortium such as user consent, transaction context, data owner group membership, data receiver group membership, and other parameters. These rules are configured on the system in the form of privacy schemas. For example, the consortium may decide to define one or more specific privacy schema, which enforce a specific privacy contract to one or more specific transaction types, defined by whom the dataset is being disclosed (i.e. data receiver membership). While a full disclosure may be permitted for some data receivers (e.g. trusted parties such as government authorities), selective disclosure mechanisms may be employed for other data receivers (e.g. 3rd party data brokers). In this way, the system provides consortium-regulated enforcement of the established privacy and consent policies, as data owners are only be able to transact their data as within the boundaries defined by the policies.

In a digital citizen identity system, a number of government departments can form a consortium of members, regulating certain aspects of how citizen identities are created, issued and presented. In this example, the departments will be operating a number of system nodes 310, with some of these systems nodes 310 configured to be consortium network members, and other system nodes 310 configured as service nodes 310. The system will need to be initially configured as per the defined system initialization processes.

A number of services for digital driving license verification can be created. A number of identity attributes can be defined, such as:
a. PII information of individual, such as data of birth, full name, current address, etc.
b. License information on any licenses provided to an individual by government agencies, for example a current driving license number, driving license categories, etc.
c. Biometrical verification data, such as an individual photo or a digital fingerprint.
d. Unique identifiers.

The system 300 can be configured in the following manner. A consortium network 360, represented by government departments, such as a citizen digital service authority, driving license authority, and law enforcement authorities, are established. Consortium members agree on specific aspects of identity management and identity attribute management, such as what identity attributes are recorded on the distributed ledger, how identity metadata is formed, how identity-centric transactions are defined, and how properties such as consent and privacy are integrated into the transactional data. A plurality of Service Networks can be defined, as to represent specific digital citizen services. A number of system nodes are configured by consortium members as per the described system initialization process. Attribute authorities and corresponding identity attributes are defined as to represent valid attributes of citizen's identities. As the consortium network is established, the consortium members are able to define data processing policies my means of privacy schemas 523 and privacy contracts 524. Privacy schemas 523 provide a policy enforcement mechanism, establishing permitted data operations. Privacy contracts 524 provide executable code instructions for each of the privacy schemas 523, which are used to implement the established policy rules. Privacy schemas 523 are created, defining conditions on how these identity attributes, corresponding identity representation, and corresponding identity assertions can be transferred between participating parties. Privacy contracts 524 are created, defining confidential data processing operations.

Specific identity representations (personas) can be created, as to represent different services implemented on the system 300. For example, in case if the system provides identity verification services for commercial KYC (know your customer) applications, a new data representation is created to provide privacy-preserved identity verification based on the digital driving license identity attributes.

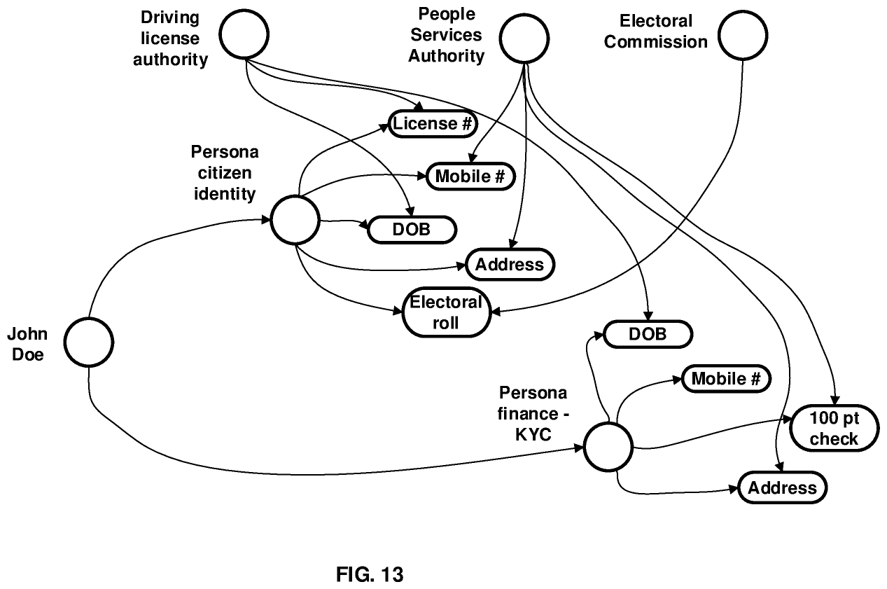

An example of multiple aggregated identity representations (personas) is shown in FIG. 13.

In this example, the system 300 can create individual representations of citizen's identities, including various identity assertions that can be used for verified proofing of identity attributes. For example, an individual (data owner) might create a new persona proofing his identity by presenting only their full name and data of birth, while not revealing other private information. In this example, the privacy and consent broker 520 will ensure that any identity data operations (such as identity data disclosure) are processed as defined in privacy schemas 523 and privacy brokers 520. It means that certain identity attributes can be disclosed only under set conditions (e.g. in specific context, under specific consent, and to an explicitly defined group of data receivers), as per the privacy schemas 523 and privacy contracts 524 configured for this particular service by the consortium network 360.

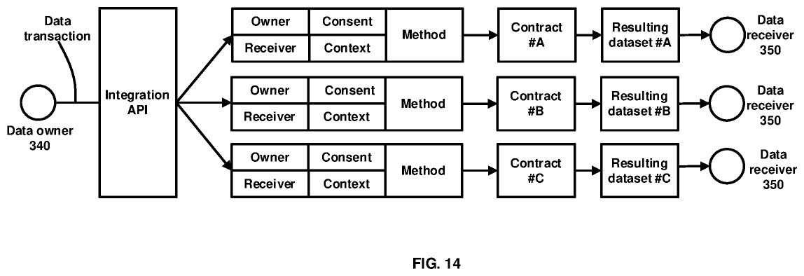

To provide an external interface for the participating parties (data owners and data receivers), a service integration API, can be implemented. An example of configured privacy schemas 523 and privacy contracts 524 is shown in FIG. 14.

Multiple privacy schemas 523 and privacy contracts 524 are implemented to provide privacy preservation and policy enforcement regarding how identity attributes can be disclosed from data owners to data receivers:

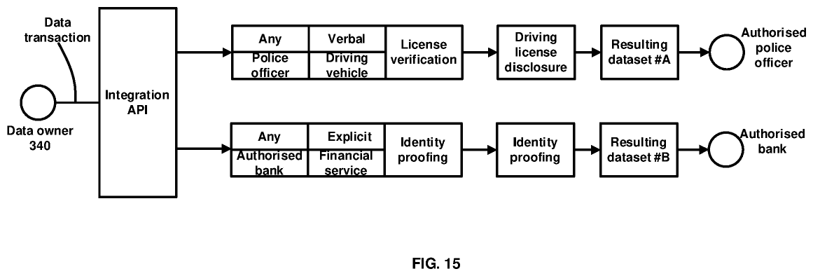

An example of configured privacy schemas and privacy contracts for digital citizen services is shown in FIG. 15.

In this example, a data owner can decide to disclose their identity to an independent party (for example, a financial institution looking forward into providing financial services to the individual). The system 300 will inspect transaction properties, identifying under which conditions the disclosure was provided (for example, if an explicit consent was received, if the data receiver is a legitimate organisation and is authorised to process PII under such conditions). Based on best-match criteria, a privacy schema 523 and a privacy contract 524 will be selected, and in case of the conditions are met the information can be disclosed.

The system 300 can be configured to provide information on generated datasets, providing data owners with details on specific data disclosures and identity verifications.

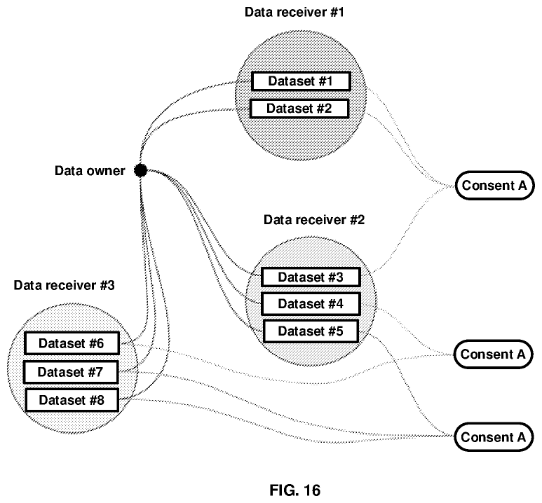

A schematic representation of disclosed datasets, grouped by data receivers and by provided consent is shown in FIG. 16.

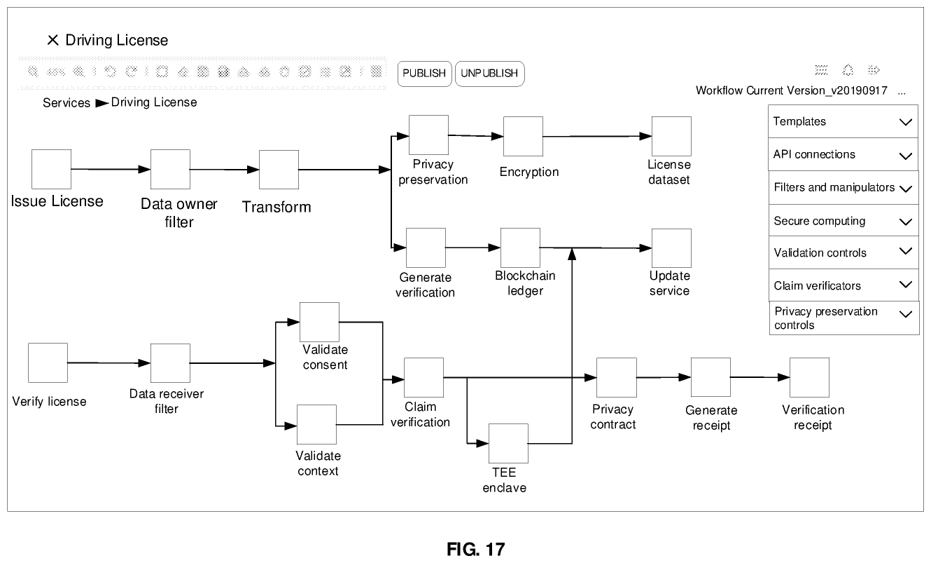

The system 300 can be configured to provide a graphical interface for the configuration of identity data processing workflows. An example graphical interface that can be used for a privacy and consent broker configuration is shown in FIG. 17. The graphical interface will enable the system operators to define system configuration parameters, and in particular define specific workflows for the system services.

In the example shown in FIG. 17, a graphical interface is used for configuration of digital driving license service, organizing configuration parameters of the system in user-friendly workflows. Workflows define privacy schemas 523 and privacy contracts 524, as well as associated configuration parameters such as transaction consent and context.

Many modifications will be appreciated throughout the specification.

1. A method of performing a transaction in relation to an identity centric dataset, wherein the method comprises:
establishing, by a consortium network, a set of permitted data operations for a service network using a plurality of privacy schemas;
receiving, by the service network, a transaction request to perform the transaction in relation to the identity centric dataset associated with a data owner;
identifying, by the service network from the plurality of schemas and based on the transaction request, a privacy schema from the plurality of privacy schemas for use in performing the transaction;
performing the transaction by executing, in a trusted execution environment of the service network, one or more data operations from the set of permitted data operations upon the identity centric dataset of the data owner as permitted by the identified privacy schema thereby generating a manipulated dataset and transaction metadata;
recording the transaction metadata to a distributed ledger of the service network; and
transferring the manipulated dataset to a data receiver indicated by the transaction request.

2. The method according to claim 1, wherein the privacy schema is identified from the plurality of privacy schemas based on at least one of the data owner and the data receiver as indicated by the transaction request.

3. The method of claim 1 or 2, further comprising transferring a transaction identifier of the transaction to the data owner.

4. The computerised system of claims 1 to 3, wherein the one or more data operations comprise at least one of:
a data transformation operation;
a data encryption operation;
a data privacy preservation operation;
a data anonymization operation;
a data pseudo-anonymisation operation;
a data tokenization operation;
a data enrichment operation;
a data label assignment operation;
a data classification label assignment operation; and
a data dissemination marker assignment operation.

5. The method according to any one of claims 1 to 4, wherein the transaction metadata is indicative of:
one or more identity attribute identifiers;
a transaction context;
consent of the data owner;
an identifier of the data owner;
an identifier of the data receiver; and
an identifier of each identifiers of the one or more data operations.

6. The method according to claim 5, wherein the transaction request is indicative of the consent of the data owner and the transaction context.

7. The method according to claim 5 or 6, wherein the privacy schema is identified from the plurality of privacy schemas based on at least one of the consent of the data owner and the transaction context.

8. The method according to any one of claims 1 to 7, wherein the manipulated dataset comprises one or more transaction data records and the transaction metadata.

9. The method according to any one of claims 1 to 8, wherein the transaction metadata is appended to the one or more transaction data records.

10. The method according to any one of claims 1 to 9, wherein the service network includes a service application programming interface (API), wherein the transaction request is received from a data owner device via the service API.

11. The method according to claim 10, wherein at least some of the manipulated dataset is encrypted by the service network based on the one or more data operations, wherein the method further comprises:
receiving, via the service API, a data access request;
determining, based on the data access request, if the data receiver is permitted to perform decryption of the at least some of the manipulated dataset; and
if the data receiver is determined to be permitted:
generating and transferring, to the data receiver, a decryption key to enable the data receiver to decrypt the at least some of the manipulated dataset; and
recording, by the service network, further transaction metadata to the distributed ledger.

12. The method according to any one of claims 1 to 9, wherein the method further comprises configuring the service network by initialising one or more system nodes based on a plurality of smart contracts and the plurality of privacy schemas distributed via a further distributed ledger, wherein the plurality of smart contracts encode the plurality of data operations.

13. The method according to claim 12, wherein the consortium network includes a plurality of system nodes, wherein the method further comprises:
establishing the service network, wherein the one or more system nodes are part of the plurality of system nodes.

14. A system of performing a transaction in relation to an identity centric dataset, wherein the system comprises one or more processing systems configured to:
establish a set of permitted data operations for a service network using a plurality of privacy schemas;
receive a transaction request to perform the transaction in relation to the identity centric dataset associated with a data owner;
identify, from the plurality of schemas and based on the transaction request, a privacy schema from the plurality of privacy schemas for use in performing the transaction;
perform the transaction by executing, in a trusted execution environment of the service network, one or more data operations from the set of permitted data operations upon the identity centric dataset of the data owner as permitted by the identified privacy schema thereby generating a manipulated dataset and transaction metadata;
record the transaction metadata to a distributed ledger of the service network; and
transfer the manipulated dataset to a data receiver indicated by the transaction request.

15. The system according to claim 14, wherein the privacy schema is identified from the plurality of privacy schemas based on at least one of the data owner and the data receiver as indicated by the transaction request.

16. The system of claim 14 or 15, wherein the consortium network is configured to transfer a transaction identifier of the transaction to the data owner.

17. The system of claims 14 to 16, wherein the one or more data operations comprise at least one of:
a data transformation operation;
a data encryption operation;
a data privacy preservation operation;
a data anonymization operation;
a data pseudo-anonymisation operation;
a data tokenization operation;
a data enrichment operation;
a data label assignment operation;
a data classification label assignment operation; and
a data dissemination marker assignment operation.

18. The system of any one of claims 14 to 17, wherein the transaction metadata is indicative of:
one or more identity attribute identifiers;
a transaction context;
consent of the data owner;
an identifier of the data owner;
an identifier of the data receiver; and
an identifier of each identifiers of the one or more data operations.

19. The system according to claim 18, wherein the transaction request is indicative of the consent of the data owner and the transaction context.

20. The system according to claim 18 or 19, wherein the privacy schema is identified from the plurality of privacy schemas based on at least one of the consent of the data owner and the transaction context.

21. The system according to any one of claims 14 to 20, wherein the manipulated dataset comprises one or more transaction data records and the transaction metadata.

22. The system according to any one of claims 14 to 21, wherein the transaction metadata is appended to the one or more transaction data records.

23. The system according to any one of claims 14 to 22, wherein the service network includes a service application programming interface (API), wherein the transaction request is received from a data owner device via the service API.

24. The system according to claim 23, wherein at least some of the manipulated dataset is encrypted by the service network based on the one or more data operations, wherein the consortium network is further configured to:
receive, via the service API, a data access request;
determine, based on the data access request, if the data receiver is permitted to perform decryption of the at least some of the manipulated dataset; and
if the data receiver is determined to be permitted:
generate and transfer, to the data receiver, a decryption key to enable the data receiver to decrypt the at least some of the manipulated dataset; and
record, by the service network, further transaction metadata to the distributed ledger.

25. The system according to any one of claims 14 to 24, wherein the one or more processing systems configure the service network by initialising one or more system nodes based on a plurality of smart contracts and the plurality of privacy schemas distributed via a further distributed ledger, wherein the plurality of smart contracts encode the plurality of data operations.

26. The system according to claim 25, wherein the consortium network includes a plurality of system nodes, wherein the one or more processing systems are configured to establish the service network, wherein the one or more system nodes are part of the plurality of system nodes.

27. One or more non-transitory computer readable mediums have stored therein or thereon executable instructions which when executed by one or more processors of one or more processing systems, configure the one or more processing systems to:
establish a set of permitted data operations for a service network using a plurality of privacy schemas;
receive a transaction request to perform the transaction in relation to the identity centric dataset associated with a data owner;
identify, from the plurality of schemas and based on the transaction request, a privacy schema from the plurality of privacy schemas for use in performing the transaction;
perform the transaction by executing, in a trusted execution environment of the service network, one or more data operations from the set of permitted data operations upon the identity centric dataset of the data owner as permitted by the identified privacy schema thereby generating a manipulated dataset and transaction metadata;
record the transaction metadata to a distributed ledger of the service network; and
transfer the manipulated dataset to a data receiver indicated by the transaction request.

28. The one or more non-transitory computer readable mediums of claim 27, wherein the privacy schema is identified from the plurality of privacy schemas based on at least one of the data owner and the data receiver as indicated by the transaction request.

29. The one or more non-transitory computer readable mediums of claim 27 or 28, wherein the consortium network is configured to transfer a transaction identifier of the transaction to the data owner.

30. The one or more non-transitory computer readable mediums of claims 27 to 29, wherein the one or more data operations comprise at least one of:
a data transformation operation;
a data encryption operation;
a data privacy preservation operation;
a data anonymization operation;
a data pseudo-anonymisation operation;
a data tokenization operation;
a data enrichment operation;
a data label assignment operation;
a data classification label assignment operation; and
a data dissemination marker assignment operation.

31. The one or more non-transitory computer readable mediums of any one of claims 27 to 30, wherein the transaction metadata is indicative of:
one or more identity attribute identifiers;
a transaction context;
consent of the data owner;
an identifier of the data owner;
an identifier of the data receiver; and
an identifier of each identifiers of the one or more data operations.

32. The one or more non-transitory computer readable mediums according to claim 31, wherein the transaction request is indicative of the consent of the data owner and the transaction context.

33. The one or more non-transitory computer readable mediums according to claim 31 or 32, wherein the privacy schema is identified from the plurality of privacy schemas based on at least one of the consent of the data owner and the transaction context.

34. The one or more non-transitory computer readable mediums according to any one of claims 27 to 33, wherein the manipulated dataset comprises one or more transaction data records and the transaction metadata.

35. The one or more non-transitory computer readable mediums according to any one of claims 27 to 34, wherein the transaction metadata is appended to the one or more transaction data records.

36. The one or more non-transitory computer readable mediums according to any one of claims 27 to 35, wherein the service network includes a service application programming interface (API), wherein the transaction request is received from a data owner device via the service API.

37. The one or more non-transitory computer readable mediums according to claim 36, wherein at least some of the manipulated dataset is encrypted by the service network based on the one or more data operations, wherein at least some of the executable instructions, which when executed by the one or more processors, configure the consortium network to:
receive, via the service API, a data access request;
determine, based on the data access request, if the data receiver is permitted to perform decryption of the at least some of the manipulated dataset; and
if the data receiver is determined to be permitted:
generate and transfer, to the data receiver, a decryption key to enable the data receiver to decrypt the at least some of the manipulated dataset; and
record, by the service network, further transaction metadata to the distributed ledger.

38. The one or more non-transitory computer readable mediums according to any one of claims 27 to 37, wherein execution of at least some executable instructions cause the one or more processing systems to configure the service network by initialising one or more system nodes based on a plurality of smart contracts and the plurality of privacy schemas distributed via a further distributed ledger, wherein the plurality of smart contracts encode the plurality of data operations.

39. The one or more non-transitory computer readable mediums according to claim 38, wherein the consortium network includes a plurality of system nodes, wherein execution of at least some of the executable instructions by the one or more processors configure the one or more processing systems to establish the service network, wherein the one or more system nodes are part of the plurality of system nodes.

40. A system for performing a transaction in relation to an identity centric dataset, the system comprising one or more processing systems configured to perform a method according to any one of claims 1 to 13.

41. One or more non-transitory computer readable mediums having stored therein or thereon executable instructions which, when executed by one or more processors of one or more processing systems, configure the one or more processing systems to perform a method according to any one of claims 1 to 13.
